(19) United States
(12) Patent Application Publication
(10) Pub. No.: US 2002/0085712 A1
(43) Pub. Date: Jul. 4, 2002

(54) Technique for efficiently generating pseudo-random bits

(75) Inventor: Rosario Gennaro, Bronx, NY (US)

Correspondence Address: Gerald R. Woods, IBM Corporation T81/503, P.O. Box 12195, Research Triangle Park, NC, 27709, US

(73) Assignee: International Business Machines Corporation, Armonk, NY (US)

(21) Appl. No.: 09/753,727

(22) Filed: Jan. 3, 2001

(51) Int. Cl. H04L 9/00

(52) U.S. Cl. 380/46

(57) ABSTRACT

The present invention provides a method, system, and computer program product for efficiently generating pseudo-random bits. A value which has a relatively short length is used as input to a generator function. In a preferred embodiment, the generator is a 1-way function based on the discrete logarithm with short exponent, or “DLSE”, problem. Preferably, the generator function uses modular exponentiation of a fixed base, modulo a safe prime number. In particular, the function may be G [symbol] x modulo P where the length of x is at least 160 bits and the length of the output at each iteration is at least 1024 bits. Thus, any 160 of the 1024 bits can be selected for use as input to the next iteration, while producing 864 pseudo-random bits per iteration. This generator exhibits an improved rate, faster computation time, and/or reduced storage requirements as contrasted to prior art generators based on the DLSE. Precomputation tables may be used, if desired, for even better efficiency.

### BACKGROUND OF THE INVENTION

1. Field of the Invention

The present invention relates to a computer system, and deals more particularly with a method, system, and computer program product for efficiently generating pseudo-random bits (e.g. for use in cryptography applications).

2. Description of the Related Art

A pseudo-random generator is a function that generates a result which appears to be random. That is, the function uses a deterministic algorithm that maps input values to output values in an unpredictable manner (such that the output values “look” like random values). Pseudo-random generators are often used in cryptography applications. Use of truly random bits in a cryptographic algorithm provides the best security, because one must know the entire set of mappings between input and output values in order to compromise the security of the algorithm. However, storing such mappings requires a considerable amount of computing resources, and sources of truly random values are scarce. Fortunately, use of pseudo-random values instead of truly random values is sufficient for most cryptographic applications.

A pseudo-random number generator, or “PRNG”, typically takes as input a relatively short random string (called a seed, or “S”) and creates a longer output string. An important property of a PRNG that is suitable for cryptographic applications is that the function on which the PRNG is based is “cryptographically strong”. That is, the PRNG should pass all polynomial-time statistical tests—or, in other words, the distribution of output sequences from the PRNG should be indistinguishable from truly random sequences using any polynomial-time judge.

Cryptographically strong, or secure, PRNGs are designed on the assumption that mathematical problems exist which are computationally infeasible to solve—that is, the problem is infeasible to solve in a realistic amount of time using even the fastest currently-available computing power. Examples of such problems include 1-way functions such as factoring of large integers, discrete logarithms, quadratic residuosity, etc.

A PRNG may also be called a pseudo-random bit generator, or “PRBG”. A number of PRBGs are known in the art. Blum and Micali presented the first secure PRBG in their paper “How to Generate Cryptographically Strong Sequences of Pseudo-Random Bits”, M. Blum and Micali, SIAM J. Computing, 13(4): 850-864 (1984). This PRBG is based on a 1-way function that computes modular exponentiation modulo some prime number P. As contrasted to more recent developments, this early secure PRBG is relatively inefficient. One measure of the efficiency of a PRBG is its “rate”, which is the ratio between the number of pseudo-random output bits generated in one iteration of the PRBG divided by the number of computations that must be performed in that iteration. The Blum-Micali PRBG generates 1 bit per modular exponentiation modulo P, or roughly 1 bit per 512 multiplications.

This rate was improved to roughly 1 bit per 50 multiplications, using precomputed 1-megabit tables of exponentiated base functions, in the teachings of Peralta (“Simultaneous Security of Bits in the Discrete Log”, R. Peralta, EUROCRYPT '85, LNCS 219, pp. 62-72 (1986)) and Long and Wigderson (“The Discrete Log Hides O(\log n) Bits”, D. Long and A. Wigderson, SIAM J. Computing, 17: 363-372 (1988)). These PRBGs are based on the discrete logarithm.

The problem of computing discrete logarithms is known in the art. If P is a prime number, and N is the length of this prime number when expressed in bits, then the expression

ZP*={x: 0<x<P}

is a group under multiplication mod P. The group is cyclic, meaning that every x in ZP* can be written as Gⁱ (equivalently, G [symbol] i) for some element G in ZP*, where G is called a “generator” of ZP*. Thus, the function which maps the integers from 1 through (P−1) into ZP* is a permutation. This function f may be expressed mathematically as

f{1,2, . . . P−1}—>ZP*

f(x)=G [symbol] x mod P

The inverse of this function f—that is, the function that determines the value of x given the value of f(x)=G [symbol] x—is called the discrete logarithm function. Computing the discrete logarithm is conjectured to be a hard mathematical problem, as previously stated. The best known algorithm for computing discrete logarithms is the so-called “index calculus” method. This algorithm, however, runs generally in time sub-exponential in N. (There are some primes P for which it is known that computing the discrete log is easy, such as those primes P for which P−1 has only small prime factors. Primes P where the result of ((P−1)/2) is not prime a number also render PRBGs based on the discrete logarithm problem subject to attack. These “unsafe” primes must be avoided.)

In some applications, it is important to speed up computation of the PRBG function. One possible way to do this is to restrict its input to small values of x. Let B be an integer bound, and assume that x must be less than B for the PRBG function y=G [symbol] x mod P. It appears to be reasonable to assume that computing the discrete logarithm of y is still hard, even knowing that x is less than some value B. Indeed, it has been demonstrated that the running time of the index calculus method depends only on the size N of the whole group ZP*. Depending on the size of B, different methods for computing the inverse of function f may actually be more efficient that the index calculus method. For example, the so-called “baby-step, giant-step” algorithm or the “rho” or “lambda” algorithms can compute the discrete logarithm of y in time proportional to the square of B. But if B is chosen large enough (e.g. if B is approximately log [symbol] 2 N bits long), then this is still too much time to be considered computationally feasible and thus provides a secure PRBG.

Thus, it can be assumed that there are no efficient algorithms for computing the discrete logarithm of y=G [symbol] x even when a bound B=2 [symbol] C where C˜log [symbol] 2 N is placed on x. This is known as the discrete logarithm with short exponent, or “DLSE”, assumption.

The DLSE is a somewhat stronger assumption than the regular discrete logarithm assumption. Using the DLSE as the base for a PRBG, Patel and Sundaram showed how to get a rate of 1.7 bits per multiplication (using 1-megabit precomputation tables) in their paper “An Efficient Discrete Log Pseudo Random Generator”, S. Patel and G. Sundaram, CRYPTO '98, LNCS 1462, pp. 304-317 (1998).

A PRBG based upon the so-called “quadratic residuosity” problem was defined in “A Simple Unpredictable Pseudo-Random Number Generator”, L. Blum, M. Blum, and M. Shub, SIAM J. Computing, 15(2): 364-383 (1986). This PRBG is also referred to as the “squaring generator”, as each iteration consists of a single squaring operation. The output of each iteration is a single bit. This rate was improved to about 10 bits per multiplication in “RSA and Rabin Functions: Certain Parts are as Hard as the Whole”, W. Alexi B. Chor, 0. Goldreich, and C. Schnorr, SIAM J. Computing, 17(2): 194-209 (1998). The teachings of Alexi et al. thus provide significant improvements over prior art techniques while relying only on the intractability of factoring as the underlying assumption.

Several U.S. Patents have been granted on the topic of generating pseudo-random bits. U.S. Pat. Nos. 5,909,494 and 4,511,988, which are titled “System and Method for Constructing a Cryptographic Pseudo Random Bit Generator” and “Electronic Event or Bit Generator Having a Predetermined Occurrence Rate with a Predetermined Event or Bit Distribution”, respectively, discuss use of stream ciphers or block ciphers to compute a PRBG. The disclosed techniques do not have a reduction to a well-defined hard mathematical problem nor do they demonstrate “provable” security. U.S. Pat. No. 5,784,002, titled “Low-Power Random Digit Generator”, discusses a technique for hardware generation of random bits (that is, bits which are truly random, and which are generated by some unpredictable physical process). Hardware generation of random bits is the best approach, but tends to be very slow and complicated. (Indeed, in practice hardware generators are typically used to produce the short random seeds which are then provided as input to a PRBG which operates much faster than the hardware generator.) U.S. Pat. No. 4,944,009, titled “Pseudo-Random Sequence Generator”, defines a technique for using a tree structure to generate pseudo-random bit sequences. A short input seed is used to derive an output sequence that may be (for example) twice as long as the input seed. The output sequence is then divided into two parts, and each part may be used to separately re-iterate the generator. This dividing and re-iterating continues, such that the output sequence expands according to a tree structure. Some bits of the output sequence may be output during the expansion. The function used is based upon polynomial equations (where the input is in the basis) modulo a composite number (where the composite number is preferably the product of two large random primes, and is 1.5 times as long as the input).

In spite of the advances that have been made in the construction and in the rate of PRBGs in recent years, there remains a need for an improved, more efficient PRBG that is based upon a hard-to-solve mathematical problem that renders discovering an inverse computationally infeasible.

### SUMMARY OF THE INVENTION

An object of the present invention is to provide an improved pseudo-random bit generator that has a provably secure mathematical basis.

Another object of the present invention is to provide a pseudo-random bit generator that has an efficient rate of generating output bits.

Yet another object of the present invention is to provide a pseudo-random bit generator that operates very quickly.

Still another object of the present invention is to provide an improved pseudo-random bit generator based upon the discrete logarithm with short exponent assumption.

A further object of the present invention is to provide an improved pseudo-random bit generator that uses exponential operations modulo a safe prime number.

Another object of the present invention is to provide an improved pseudo-random bit generator that uses an input sequence which is significantly shorter in length than the output sequence generated in each iteration.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides a method, system, and computer program product for efficiently generating pseudo-random bits. This technique comprises: providing an input value; and generating an output sequence of pseudo-random bits using the provided input value as input to a 1-way function, wherein a length of the input value is substantially shorter than a length of the generated output sequence.

In a preferred embodiment, the 1-way function is based upon an assumption known as “the discrete logarithm with short exponent” assumption. In one aspect, the 1-way function is modular exponentiation modulo a safe prime number. In this aspect, the input value is used an exponent of the modular exponentiation. Furthermore, a base of the modular exponentiation is a fixed generator value. Preferably, the length of the input value is 160 bits and a length of the safe prime number is 1024 bits. Alternatively, the lengths maybe greater than or equal to 160 and 1024, respectively. The length of the generated output sequence is also preferably 1024 bits, but may alternatively by greater than 1024 bits (and in either case, is identical to the length of the safe prime number.)

The technique of this aspect may further comprise: selecting a subset of bits from the generated output sequence as a next sequential input value, wherein a length of the selected subset is identical to the length of the input value; and generating a next sequential output sequence of pseudo-random bits using the next sequential input value as input to the 1-way function, wherein a length of the next sequential output sequence is identical to the length of the generated output sequence. The subset of bits may be a contiguous group of bits, or a non-contiguous group of bits.

The technique of this aspect may also further comprise concatenating bits of the generated next sequential output sequence which are not selected by the selection process to the generated output sequence to form a longer output sequence of pseudo-random bits. The longer output sequence may be used as input to an encryption operation.

This aspect may further comprise: repeatedly generating additional output sequences, further comprising: (a) selecting a subset of bits from a next prior generated output sequence as a next input value, wherein a length of the selected subset is identical to the length of the input value; and (b) generating a next output sequence of pseudo-random bits using the next input value as input to the 1-way function, wherein a length of the next output sequence is identical to the length of the generated output sequence; and concatenating bits of each of the repeatedly generated additional output sequences which are not selected by the selection process to form a pseudo-random output sequence.

The present invention may also be embodied as a method, system, or computer program product for performing encryption. In this case, the technique for performing encryption comprises: providing an input value; generating an output sequence of pseudo-random bits using the provided input value as input to a 1-way function, wherein a length of the input value is substantially shorter than a length of the generated output sequence; and using bits of the generated output sequence as input to an encryption operation. Preferably, the 1-way function is based upon an assumption known as “the discrete logarithm with short exponent” assumption, and may be (for example) modular exponentiation modulo a safe prime number. In this case, the input value is preferably used an exponent of the modular exponentiation, and a base of the modular exponentiation is preferably a fixed generator value.

In a preferred embodiment of this technique for performing encryption, the length of the input value is 160 bits and a length of the safe prime number, as well as the length of the generated output sequence, is 1024 bits. Alternatively, the lengths may be greater than 160 and 1024 bits.

The technique for performing encryption may further comprise: selecting a subset of bits from the generated output sequence as a next sequential input value, wherein a length of the selected subset is identical to the length of the input value; and generating a next sequential output sequence of pseudo-random bits using the next sequential input value as input to the 1-way function, wherein a length of the next sequential output sequence is identical to the length of the generated output sequence. In this case, the technique may further comprise: concatenating bits of the generated next sequential output sequence which are not selected by the selection process to the generated output sequence to form a longer output sequence of pseudo-random bits, and using bits of the generated output sequence as input to the encryption operation preferably further comprises using this longer output sequence as the input to the encryption operation.

The present invention will now be described with reference to the following drawings, in which like reference numbers denote the same element throughout.

### BRIEF DESCRIPTION OF THE DRAWINGS

FIG. 1 is a block diagram of a computer workstation environment in which the present invention may be practiced;

FIG. 2 is a diagram of a networked computing environment in which the present invention may be practiced;

FIG. 3 illustrates operation of the PRBG of a preferred embodiment of the present invention, wherein the PRBG input is significantly shorter than the number of output bits generated; and

FIG. 4 illustrates use of the PRBG of a preferred embodiment to generate a sequence of pseudo-random output bits.

### DESCRIPTION OF THE PREFERRED EMBODIMENTS

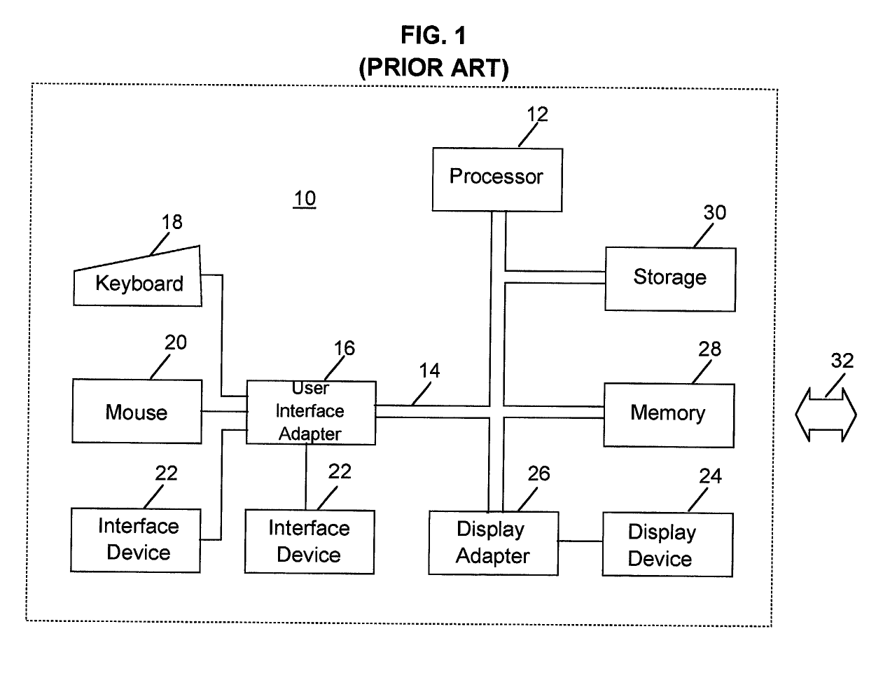

FIG. 1 illustrates a representative workstation hardware environment in which the present invention may be practiced. The environment of FIG. 1 comprises a representative single user computer workstation 10, such as a personal computer, including related peripheral devices. The workstation 10 includes a microprocessor 12 and a bus 14 employed to connect and enable communication between the microprocessor 12 and the components of the workstation 10 in accordance with known techniques. The workstation 10 typically includes a user interface adapter 16, which connects the microprocessor 12 via the bus 14 to one or more interface devices, such as a keyboard 18, mouse 20, and/or other interface devices 22, which can be any user interface device, such as a touch sensitive screen, digitized entry pad, etc. The bus 14 also connects a display device 24, such as an LCD screen or monitor, to the microprocessor 12 via a display adapter 26. The bus 14 also connects the microprocessor 12 to memory 28 and long-term storage 30 which can include a hard drive, diskette drive, tape drive, etc.

The workstation 10 may communicate with other computers or networks of computers, for example via a communications channel or modem 32. Alternatively, the workstation 10 may communicate using a wireless interface at 32, such as a CDPD (cellular digital packet data) card. The workstation 10 may be associated with such other computers in a local area network (LAN) or a wide area network (WAN), or the workstation 10 can be a client in a client/server arrangement with another computer, etc. All of these configurations, as well as the appropriate communications hardware and software, are known in the art.

Instead of, or in addition to, computer workstations, the present invention may also operate in machines such as servers, mainframes, and gateways. The architecture and components of such machines is well known, and will not be described in detail herein.

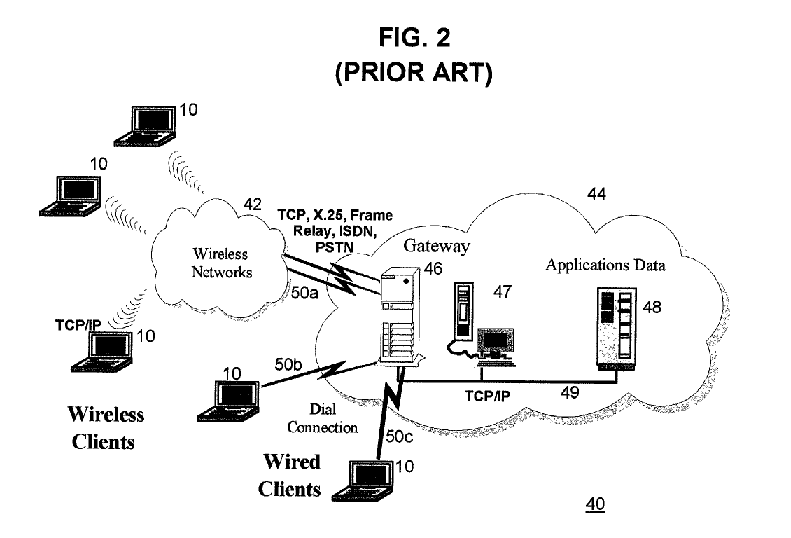

The present invention may operate on a stand-alone computing device that is not connected to a computer network or data processing network, and/or on a computing device that is connected to other computing devices in a networking environment. As an example of the latter configuration, FIG. 2 illustrates a data processing network 40 in which the present invention may be practiced. The data processing network 40 may include a plurality of individual networks, such as wireless network 42 and network 44, each of which may include a plurality of individual workstations 10. Additionally, as those skilled in the art will appreciate, one or more LANs may be included (not shown), where a LAN may comprise a plurality of intelligent workstations coupled to a host processor.

Still referring to FIG. 2, the networks 42 and 44 may also include mainframe computers or servers, such as a gateway computer 46 or application server 47 (which may access a data repository 48). A gateway computer 46 serves as a point of entry into each network 44. The gateway 46 may be preferably coupled to another network 42 by means of a communications link 50a. The gateway 46 may also be directly coupled to one or more workstations 10 using a communications link 50b, 50c. The gateway computer 46 may be implemented utilizing an Enterprise Systems Architecture/370 available from the International Business Machines Corporation (IBM), an Enterprise Systems Architecture/390 computer, etc. Depending on the application, a midrange computer, such as an Application System/400 (also known as an AS/400) may be employed. (“Enterprise Systems Architecture/370” is a trademark of IBM; “Enterprise Systems Architecture/390”, “Application System/400”, and “AS/400” are registered trademarks of IBM.)

The gateway computer 46 may also be coupled 49 to a storage device (such as data repository 48). Further, the gateway 46 may be directly or indirectly coupled to one or more workstations 10.

Those skilled in the art will appreciate that the gateway computer 46 may be located a great geographic distance from the network 42, and similarly, the workstations 10 may be located a substantial distance from the networks 42 and 44. For example, the network 42 may be located in California, while the gateway 46 may be located in Texas, and one or more of the workstations 10 may be located in New York. The workstations 10 may connect to the wireless network 42 using a networking protocol such as the Transmission Control Protocol/Internet Protocol (“TCP/IP”) over a number of alternative connection media, such as cellular phone, radio frequency networks, satellite networks, etc. The wireless network 42 preferably connects to the gateway 46 using a network connection 50a such as TCP or UDP (User Datagram Protocol) over IP, X.25, Frame Relay, ISDN (Integrated Services Digital Network), PSTN (Public Switched Telephone Network), etc. The workstations 10 may alternatively connect directly to the gateway 46 using dial connections 50b or 50c. Further, the wireless network 42 and network 44 may connect to one or more other networks (not shown), in an analogous manner to that depicted in FIG. 2.

In the preferred embodiment, the present invention is implemented in computer software. Alternatively, the present invention may be embodied in hardware, or in a combination of software and hardware. In a software embodiment, software programming code which embodies the present invention is typically accessed by the microprocessor 12 (e.g. of workstation 10, server 47, and/or a device such as gateway 46) from long-term storage media 30 of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory 28, and accessed by the microprocessor 12 using the bus 14. The techniques and methods for embodying software programming code in memory, on physical media, and/or distributing software code via networks are well known and will not be further discussed herein.

The present invention defines an improved secure pseudo-random bit generator which operates efficiently and yields a better rate as compared to prior art generators. In general, prior art generators use an N-bit long seed as a starting input for a function f. This seed value “S” may be expressed as x[0]=S. A first iteration using this seed computes the function f(x[0]) and produces a result x[1], also having N bits. The function is computed iteratively as x[i]=f(x[i−1]), with each iteration typically generating one output bit from x[i] and using the remaining bits as the next input value for x. The major cost of these prior art generators is the computation of f(x) for each value of x.

The PRBG of the present invention is based upon a 1-way function. A 1-way function, as is known in the art, generally maps a set of N-bit strings or numbers to other N-bit strings or numbers using a function that is easy to compute on an input value x. However, given an output y=f(x) of the function, it is infeasible to compute x. As contrasted to prior art PRBGs, the PRBG of the present invention uses a shorter seed. For purposes of discussion, the seed length is described herein as “C” bits in length, where C<N. All successive inputs also use C-bit values. In other words, the top (N-C) bits of each iteration are set to all zeroes. As will be discussed, the PRBG of the present invention provides a secure result when C is long enough to make infeasible specific algorithms to invert f on small inputs. The generator iteratively computes x[i]=f([x−1]), as in the prior art, but now only C bits are selected from the output N bits of each iteration as the value to be used for the next x; the remaining (N-C) bits are output as pseudorandom from each iteration. Thus, an advantage of the present invention is that it yields a higher rate than the PRBGs of the prior art. Another advantage of the PRBG is its use of very short input values (relative to the length of the prime number P, and thus to the length of each iterative output).

In a preferred embodiment, the 1-way function is modular exponentiation modulo a safe prime number P. That is, the function f(x) may be represented as G [symbol] x mod P. G is a fixed parameter called the generator, and the input values of x are used as the exponent of this generator. The safe prime number P must exhibit the properties that P−1 has only small prime factors, and that (P−1)/2 is also a prime number. An additional advantage of this preferred embodiment is that computing G [symbol] x when x is a relatively small C-bit exponent is faster than computations with general N-bit exponents. Thus, not only are more pseudo-random output bits generated than in an iteration of typical prior art PRBGs, but these iterations are faster to compute.

In particular, the bit lengths of a preferred embodiment of the PRBG of the present invention are set to 160 (or greater) for the input values (i.e. C≧160), and each iteration generates 1024 (or greater) output bits (i.e. N≧1024). Thus, when using the values 160 and 1024, each iteration yields (1024-160)=864 pseudo-random output bits.

Referring to the prior discussion of the DLSE problem, it was stated that there are no feasible algorithms that can compute the discrete logarithm of a function y=G [symbol] x mod P with small values of x, and that the running time of the index calculus method depends only on the size of N. Assume that x≦2 [symbol] C. For input values of 160 bits, this is equivalent to a requirement that each input value x≦2 [symbol] 160. This is sufficient to make the running time of the baby-step, giant-step algorithm, as well as the rho and lambda algorithms, unrealistic by today's standards. Choosing N=1024 (that is, safe prime P has 1024 bits) is also sufficient to make it hard to compute the discrete logarithm in ZP* by today's standards.

Assuming that the DLSE assumption holds, the PRBG of the present invention is an efficient and secure technique for generating pseudo-random bits. A mathematical proof (by contradiction) establishes that this new PRBG is secure. The proof is outside the scope of the present discussion, but can be found in the paper titled “An Improved Pseudo-random Generator Based on Discrete Log”, Advances in Cryptology—CRYPTO '2000, Lecture Notes in Computer Science Vol. 1880, pp. 469-481, published by Springer (August 2000), which is hereby incorporated herein by reference. (Note that this paper does not state the requirement for using safe primes such that (P−1)/2 is also a prime number. This was an oversight, and the discussions therein should be reviewed in light of this information.)

It can be demonstrated that the computation of G [symbol] x mod P with a short exponent, as disclosed herein, requires roughly (1.5 log x) modular multiplications; when x is limited to 160 bits, as discussed above, this is equivalent to (1.5 * 160) or 240 modular multiplications. Contrast this to the cost of the Patel-Sundaram generator, where the same number of pseudo-random bits would cost (1.5 * N) or 1536 modular multiplications. The modular multiplications are the most expensive operation in the PRBG of the present invention. Because the modular exponentiations are computed over the same (fixed) basis G [symbol] , the powers of G [symbol] can be precomputed and stored in a table to enable more quickly computing some particular G [symbol] x. If a table T stores values for G [symbol] (2 [symbol] i) mod P, where i takes on the integer values from 0 through C, then on average (0.5 * C) multiplications are required for computing G [symbol] for a random C-bit exponent. The table requires on the order of (C * N) bits of memory. By using a precomputation table of this type, the PRBG of the preferred embodiment requires a table of size (160 * 1024) bits or 20 kilobytes, and the function G [symbol] x can be computed with only (0.5 * 160)=80 multiplications. (As previously discussed, the precomputation tables of Peralta and of Patel-Sundaram are 1 megabit tables. Thus, the present invention provides advantages in terms of reduced storage requirements as contrasted to those prior art PRBGS.)

The rate of the PRBG in the preferred embodiment wherein C=160 and N=1024, generating 864 pseudo-random bits at each iteration, is (864-160) bits per 240 multiplications, or approximately 3.5 bits per modular multiplication. When using 20-kilobyte precomputation tables and thereby reducing the number of multiplications to 80 (as just discussed above), the rate is 704 per 80 multiplications, or approximately 9 bits per multiplication. With a 12-kilobyte table, according to the teachings of Lim and Lee (see “More Flexible Exponentiation with Precomputation”, C. H. Lim and P. J. Lee, CRYPTO '94, LNCS 830, pp. 95-107(1994)) the number of multiplications can be reduced to 40, which yields a rate of approximately 21 bits per multiplication. Using more memory, a 300-kilobyte table will yield a rate of roughly 43 pseudo-random bits per multiplication.

Thus, the PRBG of the present invention exhibits better properties than prior art PRBGs which are based on the discrete logarithm or DLSE problems. The speed is higher than the Alexi et al. generator, and it is based on a different problem (i.e. the DLSE problem, instead of the RSA factoring problem).

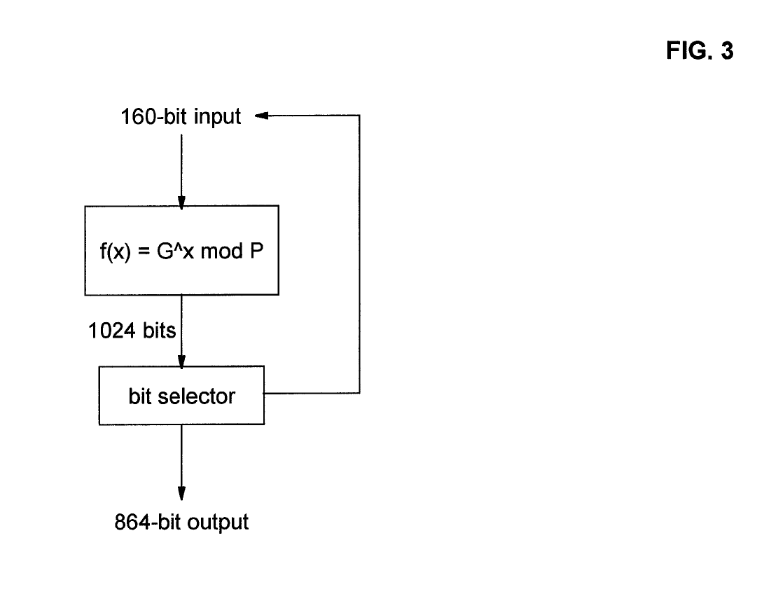

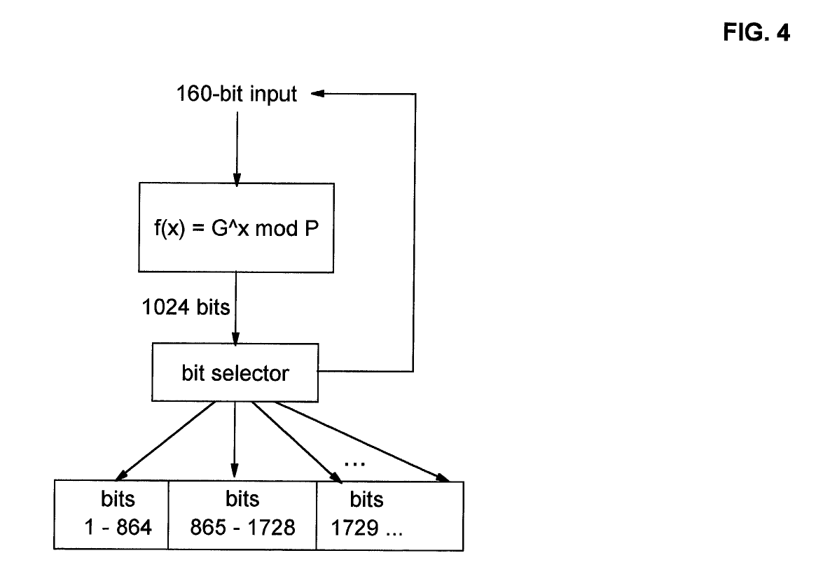

Refer to FIGS. 3 and 4 for an illustration of operation of a preferred embodiment of the PRBG of the present invention. As has been stated, the PRBG input of the present invention is significantly shorter than the number of output bits generated per iteration. FIG. 3 illustrates a single iteration of a preferred embodiment of the PRBG, using a 160-bit input value x, which is processed by the PRBG algorithm f(x)=G [symbol] x mod P to yield 1024 bits. From these 1024 generated bits, 160 are selected as input to the next iteration and 860 are used as pseudo-random output bits. Note that the 160 selected bits are not required to be the top-most bits, nor are they required to be contiguous: various selection techniques may be used without deviating from the scope of the present invention. FIG. 4 illustrates use of multiple iterations of the PRBG to generate a sequence of pseudo-random output bits. At each iteration, the 860 output bits are used in forming the output sequence, preferably by concatenating the groups of bits to the output sequence of a prior iteration. The iteration may be repeated as necessary, depending on the requirements of an application for which the PRBG is operating. (Typically, this PRBG will be used with encryption applications, for example to generate keying material, although this is for purposes of illustration and not of limitation.)

While a preferred embodiment of the present invention has been described, additional variations and modifications in that embodiment may occur to those skilled in the art once they learn of the basic inventive concepts. Therefore, it is intended that the appended claims shall be construed to include both the preferred embodiment and all such variations and modifications as fall within the spirit and scope of the invention.

What is claimed is:

1. A computer program product for efficiently generating pseudo-random bits, the computer program product embodied on one or more computer readable media and comprising:
computer-readable program code means for providing an input value; and
computer-readable program code means for generating an output sequence of pseudorandom bits using the provided input value as input to a 1-way function, wherein a length of the input value is substantially shorter than a length of the generated output sequence.

2. The computer program product according to claim 1, wherein the 1-way function is based upon an assumption known as “the discrete logarithm with short exponent” assumption.

3. The computer program product according to claim 1, wherein the 1-way function is modular exponentiation modulo a safe prime number.

4. The computer program product according to claim 3, wherein the input value is used an exponent of the modular exponentiation.

5. The computer program product according to claim 3, wherein a base of the modular exponentiation is a fixed generator value.

6. The computer program product according to claim 4, wherein the length of the input value is 160 bits and a length of the safe prime number is 1024 bits.

7. The computer program product according to claim 1, wherein the length of the input value is at least 160 bits and the length of the generated output sequence is at least 1024 bits.

8. The computer program product according to claim 1, further comprising:
computer-readable program code means for selecting a subset of bits from the generated output sequence as a next sequential input value, wherein a length of the selected subset is identical to the length of the input value; and
computer-readable program code means for generating a next sequential output sequence of pseudo-random bits using the next sequential input value as input to the 1-way function, wherein a length of the next sequential output sequence is identical to the length of the generated output sequence.

9. The computer program product according to claim 8, further comprising:
computer-readable program code means for concatenating bits of the generated next sequential output sequence which are not selected by the computer-readable program code means for selecting to the generated output sequence to form a longer output sequence of pseudo-random bits.

10. The computer program product according to claim 8, wherein the computer-readable program code means for selecting the subset of bits comprises selecting a contiguous group of bits.

11. The computer program product according to claim 8, wherein the computer-readable program code means for selecting the subset of bits comprises selecting a non-contiguous group of bits.

12. The computer program product according to claim 8, further comprising computer-readable program code means for using the longer output sequence as input to an encryption operation.

13. A system for efficiently generating pseudo-random bits in a computing environment, comprising:
means for providing an input value; and
means for generating an output sequence of pseudo-random bits using the provided input value as input to a 1-way function, wherein a length of the input value is substantially shorter than a length of the generated output sequence.

14. The system according to claim 13, wherein the 1-way function is based upon an assumption known as “the discrete logarithm with short exponent” assumption.

15. The system according to claim 13, wherein the 1-way function is modular exponentiation modulo a safe prime number.

16. The system according to claim 15, wherein the input value is used an exponent of the modular exponentiation.

17. The system according to claim 15, wherein a base of the modular exponentiation is a fixed generator value.

18. The system according to claim 16, wherein the length of the input value is 160 bits and a length of the safe prime number is 1024 bits.

19. The system according to claim 13, wherein the length of the input value is at least 160 bits and the length of the generated output sequence is at least 1024 bits.

20. The system according to claim 13, further comprising:
means for selecting a subset of bits from the generated output sequence as a next sequential input value, wherein a length of the selected subset is identical to the length of the input value; and
means for generating a next sequential output sequence of pseudo-random bits using the next sequential input value as input to the 1-way function, wherein a length of the next sequential output sequence is identical to the length of the generated output sequence.

21. The system according to claim 20, further comprising:
means for concatenating bits of the generated next sequential output sequence which are not selected by the means for selecting to the generated output sequence to form a longer output sequence of pseudo-random bits.

22. The system according to claim 20, wherein the means for selecting the subset of bits comprises selecting a contiguous group of bits.

23. The system according to claim 20, wherein the means for selecting the subset of bits comprises selecting a non-contiguous group of bits.

24. The system according to claim 20, further comprising means for using the longer output sequence as input to an encryption operation.

25. A method for efficiently generating pseudo-random bits, comprising the steps of:
providing an input value; and
generating an output sequence of pseudo-random bits using the provided input value as input to a 1-way function, wherein a length of the input value is substantially shorter than a length of the generated output sequence.

26. The method according to claim 25, wherein the 1-way function is based upon an assumption known as “the discrete logarithm with short exponent” assumption.

27. The method according to claim 25, wherein the 1-way function is modular exponentiation modulo a safe prime number.

28. The method according to claim 27, wherein the input value is used an exponent of the modular exponentiation.

29. The method according to claim 27, wherein a base of the modular exponentiation is a fixed generator value.

30. The method according to claim 28, wherein the length of the input value is at least 160 bits and a length of the safe prime number is at least 1024 bits.

31. The method according to claim 25, wherein the length of the input value is 160 bits and the length of the generated output sequence is 1024 bits.

32. The method according to claim 25, wherein the length of the input value is at least 160 bits and the length of the generated output sequence is at least 1024 bits.

33. The method according to claim 25, further comprising the steps of:
selecting a subset of bits from the generated output sequence as a next sequential input value, wherein a length of the selected subset is identical to the length of the input value; and
generating a next sequential output sequence of pseudo-random bits using the next sequential input value as input to the 1-way function, wherein a length of the next sequential output sequence is identical to the length of the generated output sequence.

34. The method according to claim 33, further comprising the step of concatenating bits of the generated next sequential output sequence which are not selected by the selecting step to the generated output sequence to form a longer output sequence of pseudo-random bits.

35. The method according to claim 33, wherein the step of selecting the subset of bits comprises selecting a contiguous group of bits.

36. The method according to claim 33, wherein the step of selecting the subset of bits comprises selecting a non-contiguous group of bits.

37. The method according to claim 33, further comprising the step of using the longer output sequence as input to an encryption operation.

38. The method according to claim 25, further comprising the steps of:
repeatedly generating additional output sequences, further comprising the steps of
selecting a subset of bits from a next prior generated output sequence as a next input value, wherein a length of the selected subset is identical to the length of the input value; and
generating a next output sequence of pseudo-random bits using the next input value as input to the 1-way function, wherein a length of the next output sequence is identical to the length of the generated output sequence; and
concatenating bits of each of the repeatedly generated additional output sequences which are not selected by the selecting step to form a pseudo-random output sequence.

39. An encryption system, comprising:
means for providing an input value;
means for generating an output sequence of pseudo-random bits using the provided input value as input to a 1-way function, wherein a length of the input value is substantially shorter than a length of the generated output sequence; and
means for using bits of the generated output sequence as input to an encryption operation.

40. The encryption system according to claim 39, wherein the 1-way function is based upon an assumption known as “the discrete logarithm with short exponent” assumption.

41. The encryption system according to claim 39, wherein the 1-way function is modular exponentiation modulo a safe prime number.

42. The encryption system according to claim 41, wherein the input value is used an exponent of the modular exponentiation.

43. The encryption system according to claim 41, wherein a base of the modular exponentiation is a fixed generator value.

44. The encryption system according to claim 42, wherein the length of the input value is 160 bits and a length of the safe prime number is 1024 bits.

45. The encryption system according to claim 39, wherein the length of the input value is 160 bits and the length of the generated output sequence is 1024 bits.

46. The encryption system according to claim 39, further comprising:
means for selecting a subset of bits from the generated output sequence as a next sequential input value, wherein a length of the selected subset is identical to the length of the input value; and
means for generating a next sequential output sequence of pseudo-random bits using the next sequential input value as input to the 1-way function, wherein a length of the next sequential output sequence is identical to the length of the generated output sequence.

47. The encryption system according to claim 46, further comprising:
means for concatenating bits of the generated next sequential output sequence which are not selected by the means for selecting to the generated output sequence to form a longer output sequence of pseudo-random bits; and
wherein the means for using bits of the generated output sequence as input to the encryption operation further comprises means for using the longer output sequence as the input to the encryption operation.
